(19) United States
(12) Patent Application Publication
(10) Pub. No.: US 2014/0207552 A1
(43) Pub. Date: Jul. 24, 2014

(54) PUBLISHING AND REDEEMING ELECTRONIC MANUFACTURER COUPONS

(71) Applicant: CELILO GROUP MEDIA, Portland, OR (US)

(72) Inventor: Nicholas Blosser, Portland, OR (US)

(73) Assignee: CELILO GROUP MEDIA, Portland, OR (US)

(21) Appl. No.: 13/747,334

(22) Filed: Jan. 22, 2013

(51) Int. Cl. G06Q 30/02

(52) U.S. Cl. CPC G06Q 30/0239
USPC 705/14.26; 705/14.39

(57) ABSTRACT

A facility for distributing and redeeming electronic manufacturer coupons is described. The facility receives user input selecting a merchant location and displays information about offers redeemable at the selected merchant location that include at least one electronic manufacturer coupon. The facility receives user input requesting redemption of an electronic manufacturer coupon at the selected merchant location, and in response displays information about the distinguished electronic manufacturer coupon including a code for redemption of the offer, records data about the redemption, and transmits recorded redemption data.

### CROSS REFERENCE TO RELATED APPLICATION(S)

This application is related to U.S. patent application Ser. No. 13/038,256, filed Mar. 1, 2011, entitled “PROVIDING COUPONS VIA A MOBILE DEVICE,” which is incorporated herein in its entirety by reference, and to U.S. patent application Ser. No. 13/356,566, filed Jan. 23, 2012, entitled “PROVIDING COUPONS VIA A MOBILE DEVICE,” which is incorporated herein in its entirety by reference.

### BACKGROUND

Coupons are instruments that entitle their bearers to special deals from particular merchants. For example, a coupon issued by a coffee shop might entitle its bearer to two beverages for the price of one, or a free muffin with a beverage, or 20% off the price of a beverage.

A manufacturer coupon is a coupon issued by or on behalf of the manufacturer of a particular product that entitles its bearer to a special deal on that product when purchased at a variety of merchants. For example, a coupon issued by a laundry detergent maker might entitle its bearer to 50¢ off a particular size container of a particular brand of detergent that is available at various merchants.

Coupons have historically been printed on paper, either in specialized coupon books, or as part of other publications such as newspapers and magazines. In order to redeem such a coupon, a customer typically tears it out of another publication in which it was printed and hands it to the cashier at the merchant, who in response provides the deal indicated by the coupon to the customer.

Merchant locations that offer a manufacturer's products typically accept the manufacturer's coupons for those products. After a merchant redeems a manufacturer coupon, the merchant typically sends the coupon to a clearinghouse for processing and reimbursement from the manufacturer at an amount greater than the face value of the coupon. If the merchant wishes to track the use of coupons by its customers, it typically does so manually, relying on its own employees.

### BRIEF DESCRIPTION OF THE DRAWINGS

FIG. 1 is a network diagram showing an arrangement of components used to provide the facility in some embodiments.

FIG. 2 is a block diagram showing some of the components typically incorporated in at least some of the computer systems and other devices on which the facility operates.

FIGS. 3A-3C contain a flow diagram showing steps performed by the facility in some embodiments in order to provide the experience of purchasing, selecting, and redeeming manufacturer coupons on a mobile device.

FIGS. 4-17 are display diagrams each depicting a sample display presented by the facility in some embodiments.

FIG. 18 is a report diagram showing a sample manufacturer coupon redemption report typical of those generated for a merchant by the facility in some embodiments.

FIG. 19 is a report diagram showing a sample manufacturer coupon redemption report typical of those generated for a manufacturer by the facility in some embodiments.

### DETAILED DESCRIPTION

The inventors have identified substantial disadvantages in conventional approaches to publishing and redeeming manufacturer coupons from the customer's perspective. As a first matter, it often requires significant effort for a customer to remember to bring coupons along when the customer leaves the house, and to carry the coupons, which may be in one or more large books, a file folder, or a zip-closure bag. It is also difficult for the customer to recognize opportunities to use coupons—such as when the customer arrives at a merchant for which he or she has a coupon—and to be able to locate the correct coupon among the many coupons that he or she is carrying. Also, when proceeding conventionally, it is difficult for the customer to select a particular merchant for a buying task (e.g., a particular brand of fruit juice) on the basis of whether the customer has a manufacturer coupon redeemable at a merchant that could satisfy that buying task. It can also be difficult for a customer to determine whether the customer has a coupon redeemable at any merchant near whatever location the customer finds him or herself in. Also, where coupons are shared by two or more people such as spouses or an entire family, only one of these people at a time can physically possess a particular coupon, and the ability to redeem that coupon is limited to the person who possesses it, preventing any others with whom it is shared from redeeming it.

The inventors have also identified substantial disadvantages in conventional approaches to publishing and redeeming manufacturer coupons from the merchant's perspective. First, it is often relatively easy for customers to counterfeit paper coupons, such as by copying them with a photocopier. Manufacturers may refuse to reimburse merchants for such counterfeit coupons, resulting in a loss to the merchant. Also, it can be extremely burdensome for a merchant to track and analyze coupon redemptions to determine the frequency of redemption at certain locations, during certain date and time ranges, among different coupons, etc. Processing redeemed paper manufacturer coupons through a third party clearinghouse incurs costs and takes time, resulting in a delay between the redemption of the coupon and reimbursement to the merchant.

The inventors have also identified substantial disadvantages in conventional approaches to publishing and redeeming manufacturer coupons from the manufacturer's perspective. Manufacturers must expend resources to guard against and identify misredemption of paper coupons, such as the redemption of illicit copies of an otherwise valid coupon that were each intended for redemption by a single customer. Such illicit copies may be made and used by, e.g., an unscrupulous (or fake) merchant submitting coupons that were never used by a consumer, or a single customer obtaining and using more copies of a coupon than the terms of an offer allow. Coupon misredemption can cost a manufacturer significant amounts without generating additional consumer interest in the relevant product. Third party clearinghouses that process redeemed paper manufacturer coupons can also submit improperly redeemed coupons to manufacturers for payment. Manufacturers may not receive high quality data regarding coupon redemptions including, e.g., what individual offers were redeemed at what merchant locations at what dates and times and with what other products or offers. Finally, printing coupons on paper and physically distributing those paper coupons to consumers and processing redeemed paper coupons can incur a significant resource cost and associated pecuniary expense.

Seeking to overcome these disadvantages, the inventors have designed a hardware and/or software facility for providing manufacturer coupons via a mobile electronic device such as a wireless phone (“the facility”). In some embodiments, a customer (“user”) installs a coupon application on his or her mobile device. The user uses the application to establish an account with the facility; purchase or otherwise obtain manufacturer coupons redeemable at merchants having one or more locations in a particular geographic area; identify manufacturer coupons likely to prove useful; and redeem identified manufacturer coupons with the corresponding merchants. Electronic coupons of this type can typically be created, circulated, and used at resource costs and pecuniary expenses that are both significantly less than those for paper coupons.

In various embodiments, a consumer goods manufacturer generates an electronic coupon for one or more of its products. The coupon is circulated to merchants that each have the opportunity to choose whether to accept the coupon at one or more of its locations. In some embodiments, merchants or individual merchant locations opt in to accept individual coupon offers during a defined subscription period. In some embodiments, a merchant agrees to accept electronic manufacturer coupons for all applicable products the merchant indicates it carries during a particular period.

The facility makes the electronic manufacturer coupon available to a user via a mobile computing device. In various embodiments, the facility enables users to access electronic manufacturer coupons on their mobile phones via a mobile electronic coupon application (“app”). The app enables users to find a convenient merchant location where an item is available for purchase and the corresponding coupon will be accepted.

In various embodiments, the facility provides various techniques for identifying coupons likely to prove useful, such as by combinations of one or more of the following: listing all available coupons; listing only coupons in a merchant category selected by the user; listing only coupons matching a search string specified by the user; listing coupons based upon the distance to a relevant merchant from the user's present location; listing all coupons that might be of interest to the user based upon the user's favorite coupons or previous coupon redemptions; listing all coupons that might be of interest based upon their membership in or affiliation with an organization; and sorting listed coupons based upon some attribute, such as merchant name, deal type, expected amount of savings, merchant type, distance to the merchant from the user's current location, etc.

In some embodiments, multiple users and/or multiple mobile devices may share a single account with the facility, such that any coupon purchased or obtained for the account is available for selection and redemption by any of the sharing users and/or mobile devices.

In some embodiments, a user who has purchased or obtained a coupon can transfer that coupon to a different user or account, such as by wirelessly transmitting the coupon to the receiving user's mobile device.

In some embodiments, when a user arrives at a merchant location, the app displays all of the coupons that are available to redeem at that merchant location, including manufacturer coupons that the merchant location has opted to accept as well as coupons the merchant itself offers for that location. The user can select any of the available coupons for redemption—e.g., store coupons and/or manufacturer coupons.

In some embodiments, when the user reaches the cashier, to redeem the coupons, the facility displays each one in turn for the cashier to optically scan, such as with a handheld scanner connected to the point-of-sale terminal, or for the cashier to type in a displayed coupon code. In some embodiments, the facility causes a special animation to be played as part of a redemption display that is presented on the mobile device when its user redeems a coupon. This animation, whose appearance changes as it is displayed, prevents customers from counterfeiting coupons by simply capturing and re-displaying a still image of the redemption display.

In some embodiments, as soon as a network connection (e.g., a cellular or Wi-Fi wireless network connection) is available from the user's mobile phone, the app uploads redemption transaction data for each of the redeemed coupons, indicating the identity of the coupon, the identity of the user, the time and date, and the geographic location at the time of redemption.

For each coupon redemption record corresponding to a manufacturer coupon, the merchant is paid an amount that is generally at least as much as the face value of the coupon, and the manufacturer is billed for this merchant reimbursement amount, plus a service fee. In some embodiments, the facility generates for some or all merchants who redeem coupons with the facility redemption reports that detail the redemption of each coupon, including manufacturer coupons, redeemed by the merchant and each merchant location during a specified time range. In some embodiments, the facility generates for some or all manufacturers who publish coupons with the facility reports showing, for a particular manufacturer, the redemption of its coupons at each merchant, at each location.

The facility employs algorithms to verify that manufacturer coupon redemptions are correctly associated with the merchant locations that the user selected for those redemptions. For example, in some embodiments, the facility obtains user location information (e.g., from GPS data, cell tower triangulation, or Wi-Fi hotspot location) related to each coupon redemption. Such location information enables the facility to determine whether the user-selected redemption location matches the facility-obtained location information. For example, if the locations do not match, but the facility-obtained location information corresponds with an alternative merchant location where the manufacturer coupon can be redeemed, in some embodiments the facility ascribes the redemption to the alternative merchant location instead of the user-selected merchant location.

The facility also analyzes transaction information to identify potential user error or misredemption. Such analytics provide useful data even when, for example, the facility does not obtain user location information for a redemption, e.g., because the user has not given permission for the app to know the user's mobile device location, or because the user's mobile device was unable to provide location information. In some embodiments, the facility examines a user's total redemptions without location data and compares, e.g., their number, amount, and/or concentration to norms such as averages for similarly situated users or all users. The facility uses such comparisons to detect unusual patterns, e.g., a user logging redemptions of dozens or hundreds of coupons at a particular merchant. In some embodiments, the facility compares user redemption records to merchant point-of-sale redemption data for the same manufacturer coupons to identify discrepancies.

The facility also reviews redemptions at merchants and individual merchant locations to identify potential merchant error or misredemption. The facility, by detecting or revealing various discrepancies, patterns, or issues in manufacturer coupon redemption information, enables further investigation to resolve potential issues. For example, in some embodiments, the facility identifies a merchant or a merchant location at which an unusually high or higher than accepted percentage of redemptions come from users for which the facility does not obtain user location information. In some embodiments, the facility identifies a user device or account with higher than expected volumes of redemptions. In some embodiments, the facility identifies a suspiciously high volume or frequency of redemptions by different users at a merchant, e.g., manufacturer coupon redemption records showing that 1,000 users redeemed a coupon within a two-minute period at a single merchant location. In some embodiments, the facility identifies a merchant or merchant location that has a significantly higher manufacturer coupon redemption volume than expected based on its size, e.g., a small store showing five times the redemptions of a chain of four larger stores. By detecting anomalous data, the facility can be used to prompt investigation and resolution of potential misredemption of manufacturer coupons.

By behaving in one or more of these ways, the facility makes the process of using coupons easier for customers; more useful and convenient to merchants and manufacturers; and less resource intensive.

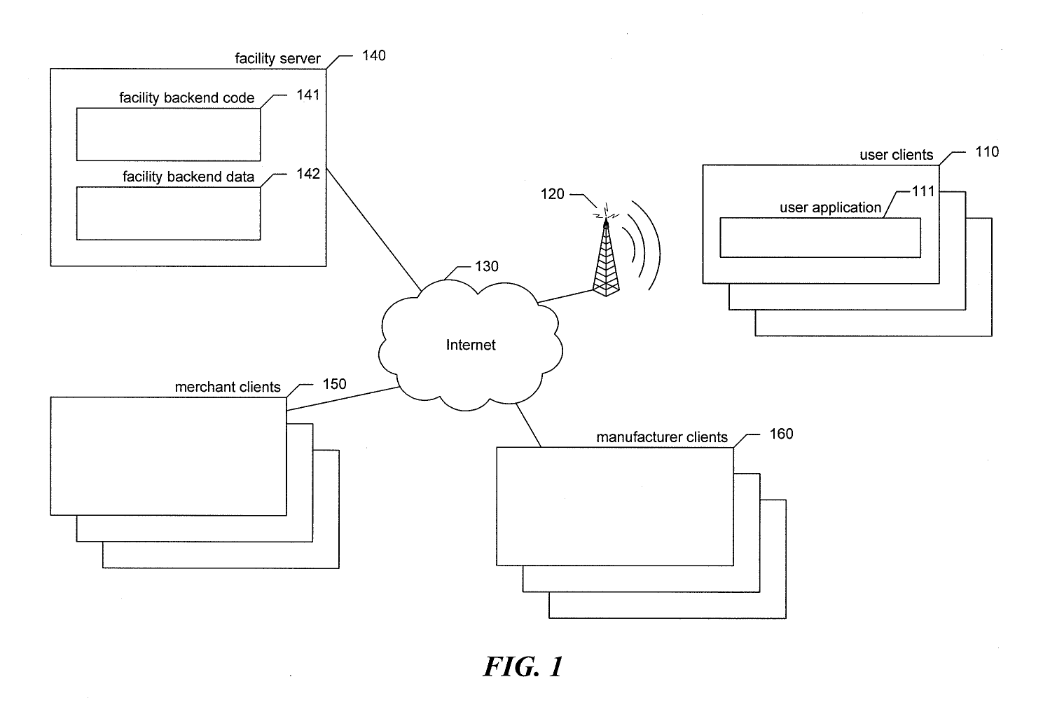

Turning now to the figures, FIG. 1 is a network diagram showing an arrangement of components used to provide the facility in some embodiments. Users interact with a user application 111 executing on a number of user clients 110—such as smartphones or similar mobile devices—to purchase or otherwise obtain coupons and/or packs of multiple coupons and find and redeem coupons. The customer application communicates wirelessly, such as via a wireless base station 130, and then via the Internet 140 or other network, with a facility server 140. The facility server stores account information, receives and processes payment information, and provides coupons (and/or coupon packs) and supporting data. The facility server includes both facility backend code 141 and facility backend data 142. The facility server also produces coupon purchase and/or redemption reports that can be retrieved from the facility server and reviewed by merchants using merchant clients 150, and coupon access, purchase, and/or redemption reports that can be retrieved from the facility server and reviewed by manufacturers using manufacturer clients 160.

In various embodiments, various aspects of functionality attributed to the facility server above are distributed to customer clients and/or merchant or manufacturer clients. While various embodiments are described in terms of the environment described above, those skilled in the art will appreciate that the facility may be implemented in a variety of other environments including a single, monolithic computer system, as well as various other combinations of computer systems or similar devices connected in various ways.

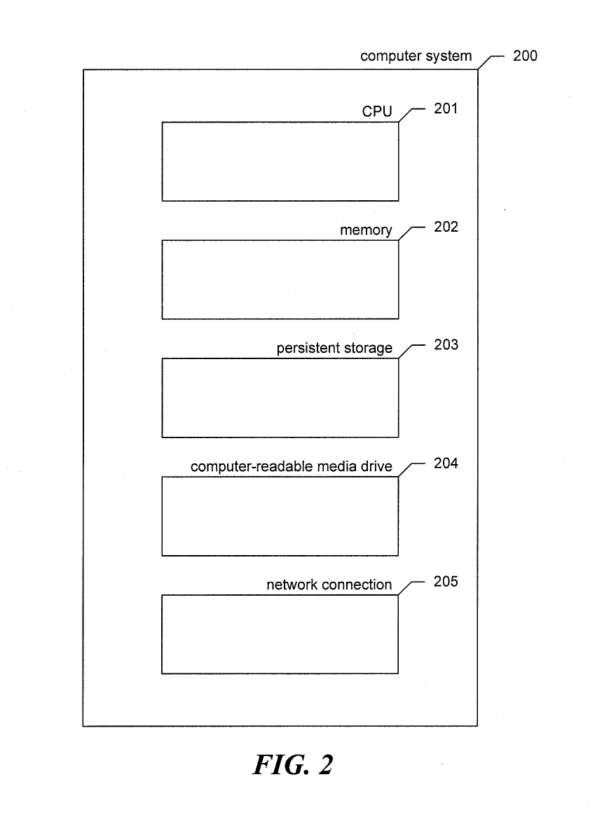

FIG. 2 is a block diagram showing some of the components typically incorporated in at least some of the computer systems and other devices on which the facility operates. In various embodiments, these computer systems and other devices 200 can include server computer systems, desktop computer systems, laptop computer systems, mobile phones, personal digital assistants, tablet computers, televisions, cameras, automobile computers, automobile computers interacting in a wireless and/or wired manner with another device carried into the automobile such as a mobile phone or laptop computer system, electronic media players, etc. In various embodiments, the computer systems and devices include zero or more of each of the following: a central processing unit (CPU) 201 for executing computer programs; a computer memory 202 for storing programs and data while they are being used; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet, a wireless network, or another network and its networking hardware. While computer systems configured as described above are typically used to support the operation of the facility, those skilled in the art will appreciate that the facility may be implemented using devices of various types and configurations, and having various components.

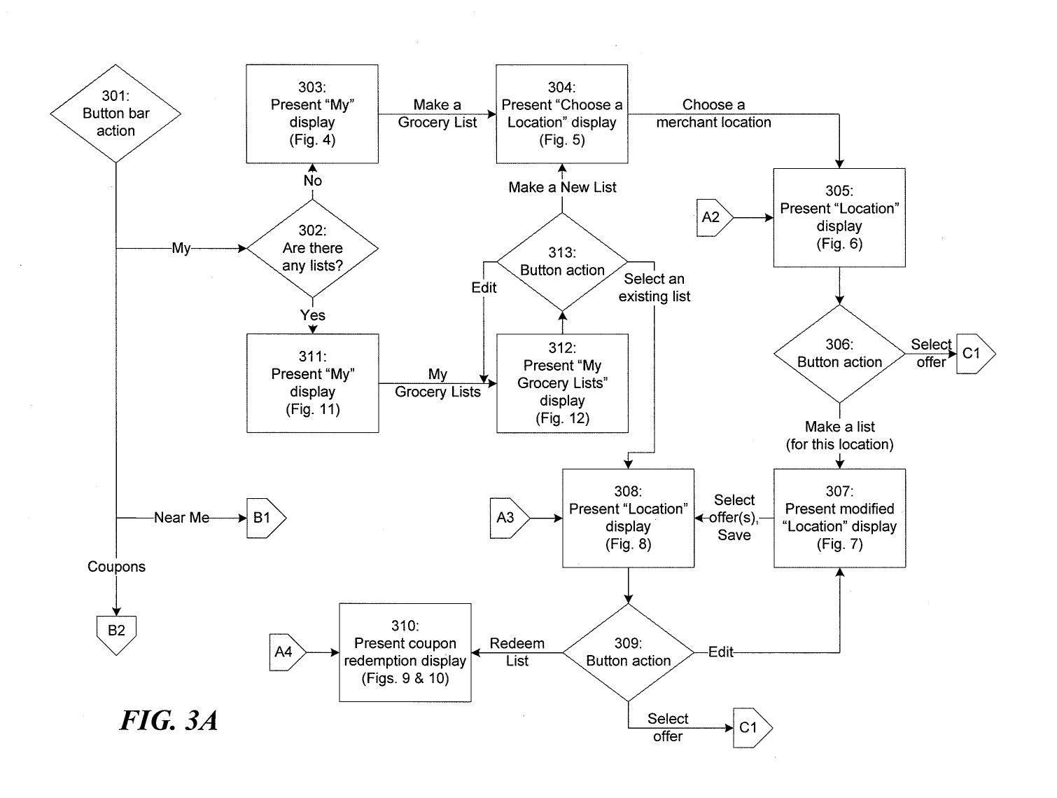

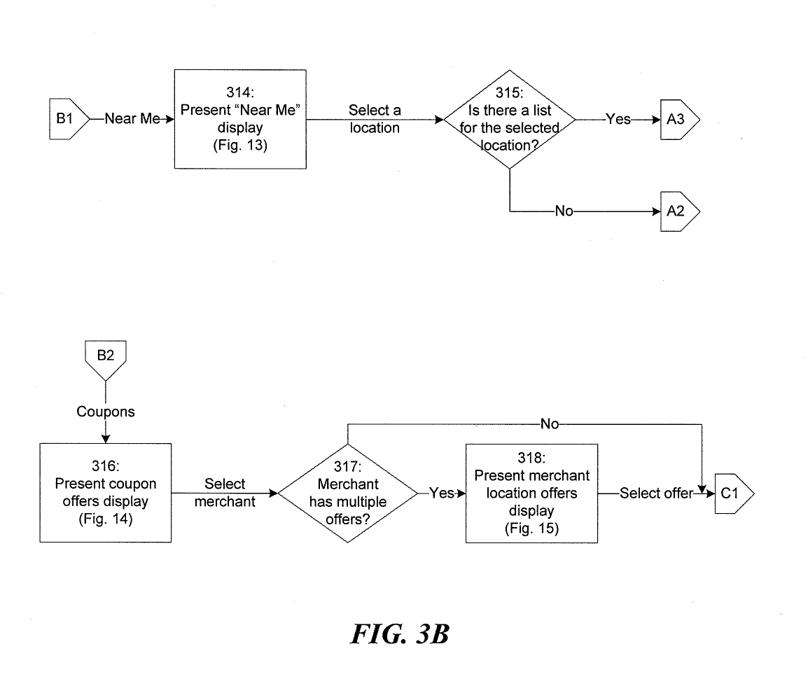

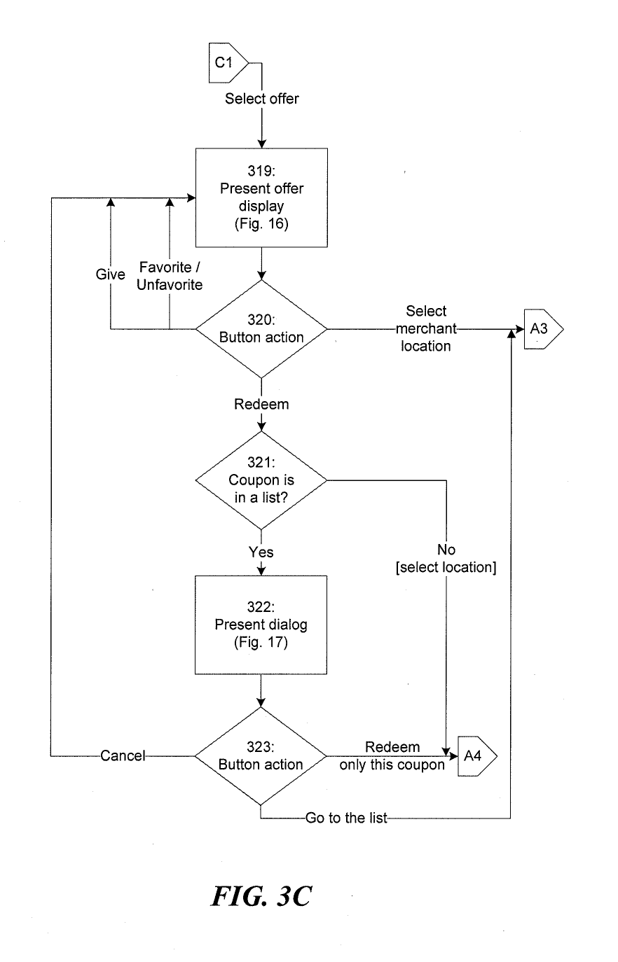

FIGS. 3A-3C contain a flow diagram showing steps performed by the facility in some embodiments in order to provide the experience of purchasing, selecting, and redeeming manufacturer coupons on a mobile device. In some or all cases, the facility presents a display that includes a button bar that the user may use in order to select high-level functionalities of the facility.

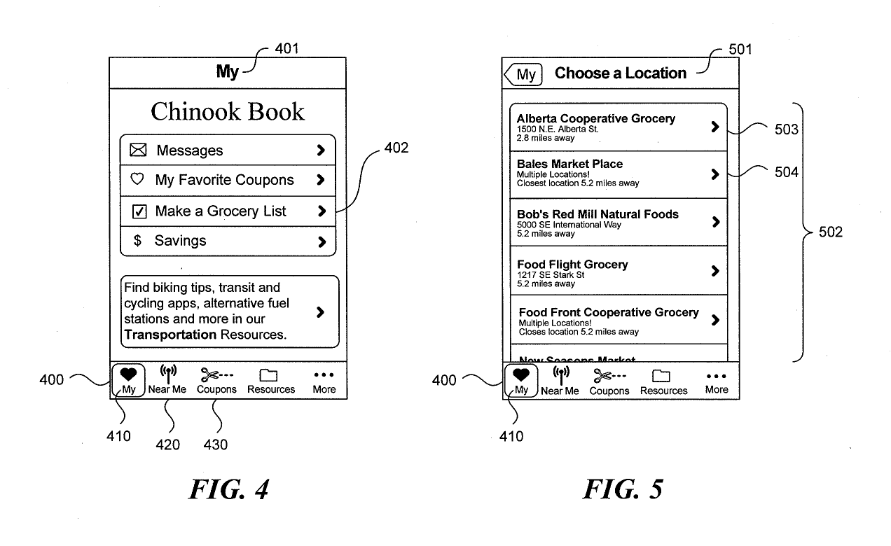

For example, the “My” display shown in FIG. 4 includes a button bar 400. The button bar includes a “My” button 410, a “Near Me” button 420, and a “Coupons” button 430, as well as additional buttons for more functionalities. Starting in FIG. 3A, in step 301, the facility acts on the user's selection of a button in the button bar. The facility branches based on the button selected: if the user selected a “My” button, the facility continues in step 302; if the user selected a “Near Me” button, then the facility continues through connector B1 to step 314, shown in FIG. 3B; and if the user selected a “Coupons” button, then the facility continues through connector B2 to step 316, shown in FIG. 3B.

Continuing in FIG. 3A, in step 302, if the user has not yet created a list of coupons, such as a grocery list, for redemption at a particular merchant or merchant location, then the facility continues in step 303, else the facility continues in step 311. In step 303, the facility presents a “My” display, shown in FIG. 4. The title bar 401 displays “My”, and the “My” button 410 in the button bar 400 is highlighted, while the other buttons in the button bar (e.g., the “Near Me” button 420 and the “Coupons” button 430) are not highlighted. From the FIG. 4 “My” display, the user can select a button 402 to make a list. In the illustrated embodiment, the button 402 is labeled “Make a Grocery List”; those skilled in the art will appreciate that the facility is not limited to coupons or merchants of any particular type or category. After the user selects the button 402, the facility continues in step 304.

In step 304, the facility presents the display shown in FIG. 5. Titled “Choose a Location” 501, the display prompts the user to choose, from a list of merchants 502, a merchant where the user would like to create a new list. In the illustrated embodiment, the list of merchants 502 is presented in alphabetical order; in some embodiments, the list of merchants 502 is sorted, e.g., by distance from the user, by merchant popularity, by recent activity, by offer value, or by criteria selectable by the user. Each merchant listing in the list of merchants 502 provides the name of the merchant, either the address (if the merchant has only one location) or an indication of multiple locations, the distance from the user's mobile device to the merchant's location or (in the case of multiple locations) the closest merchant location, and an indication that the user can select the merchant listing as a button. For example, the first merchant listing 503 is a merchant with a single location; the second merchant listing 504 is a merchant with multiple locations. If the user chooses a merchant with multiple locations, e.g., the second merchant listing 504, the facility presents a display (not shown) listing locations of that merchant for the user to select. When the user selects one of the locations from such a list of one merchant's locations or selects, from the list of merchants 502 a merchant with a single location, e.g., the first merchant listing 503, the facility continues in step 305.

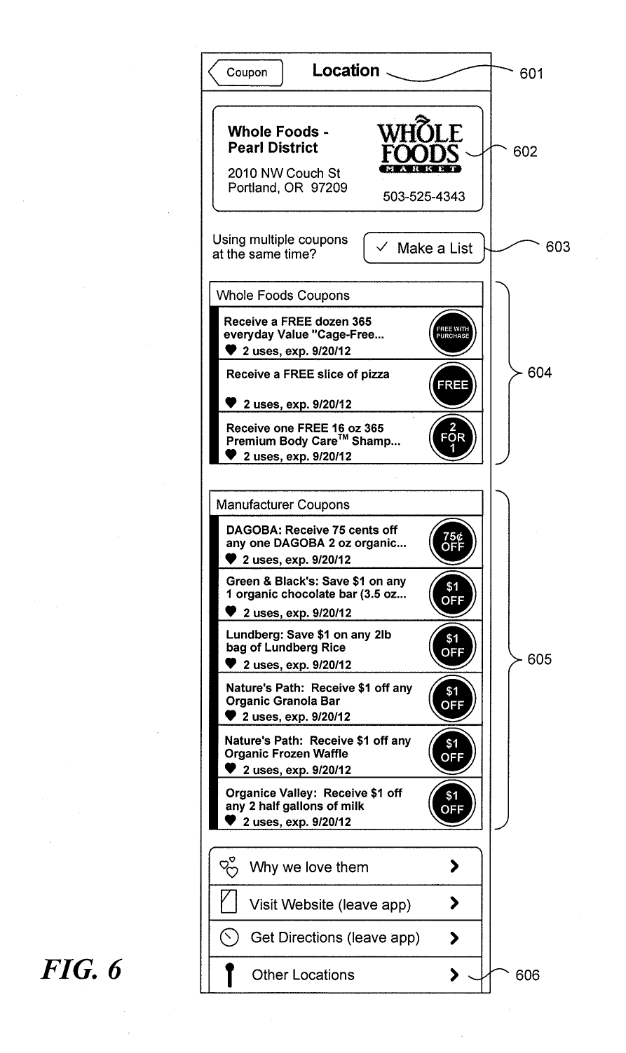

In step 305, the facility presents a “Location” display, shown in FIG. 6. Below the “Location” title bar 601, the display includes information about the selected merchant location 602 and a button 603 prompting the user to begin making a list of coupon offers to redeem. The facility displays both merchant coupons 604 and manufacturer coupons 605 that the displayed merchant location will redeem. In some embodiments, the order in which coupons are listed is tailored to the user, e.g., by listing offers available to the user above used or otherwise unavailable coupons, coupons flagged by the user as favorites above coupons not so marked, higher value coupons above lower value offers, soon-to-expire offers above those with long expiration dates, etc.

Among various options for the user in FIG. 6, if a merchant has multiple locations, an “Other Locations” button 606 enables the user to choose a different location for the same merchant, after which the facility continues again in step 305. In step 306, the facility branches based upon the button selected by the user. If the user selects the “Make a List” button 603, then the facility continues in step 307; if the user selects one of the individual merchant coupons in list 604 or one of the individual manufacturer coupons in list 605, then the facility continues through connector C1 to step 319 in FIG. 3C.

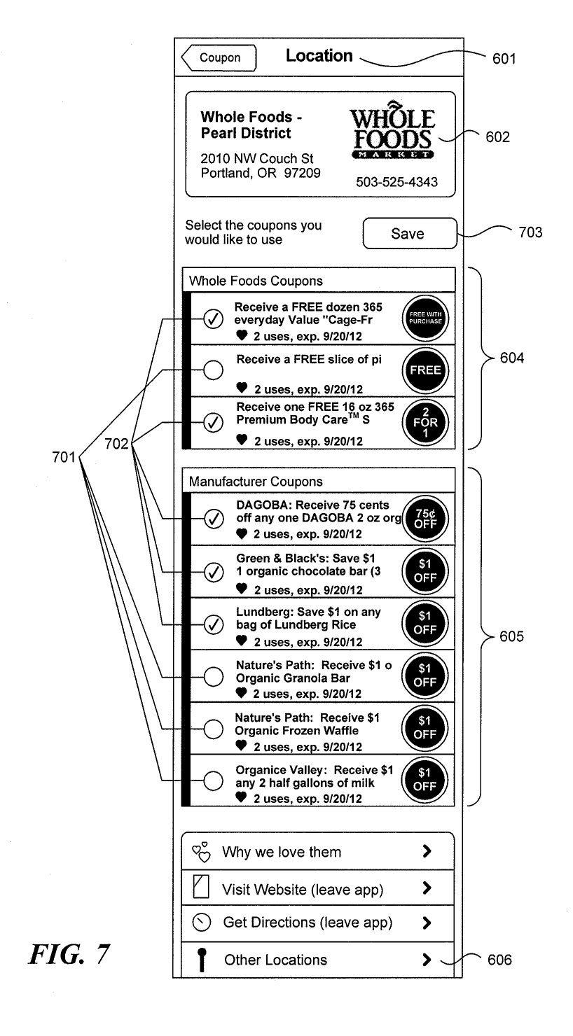

Continuing in FIG. 3A, in step 307, the facility presents a modified version of the FIG. 6 “Location” display, shown in FIG. 7. The title bar 601, the merchant location information 602, the list of merchant coupons 604, the list of manufacturer coupons 605, and (where applicable) the other locations button 606 are displayed, similar to the display presented in step 305. In step 307, however, the facility enables the user to add coupons to a list. In particular, the display of the list of merchant coupons 604 and the list of manufacturer coupons 605 is altered by the addition of empty checkboxes 701 next to each coupon that the user can select to add to a list of coupons to be redeemed, and checked checkboxes 702 next to each coupon that the user has selected for the list. When the user begins creating a new list (as, e.g., when step 307 follows steps 305 and 306), each coupon initially has an empty checkbox 701. After the user has selected some coupons for the list, or when the user is editing an existing list that has some already-selected coupons (as, e.g., when step 307 follows steps 308 and 312), some coupons will have checked checkboxes as illustrated in FIG. 7. The facility displays a “Save” button 703 prompting the user to complete the list. When the user selects the “Save” button 703, the facility continues in step 308.

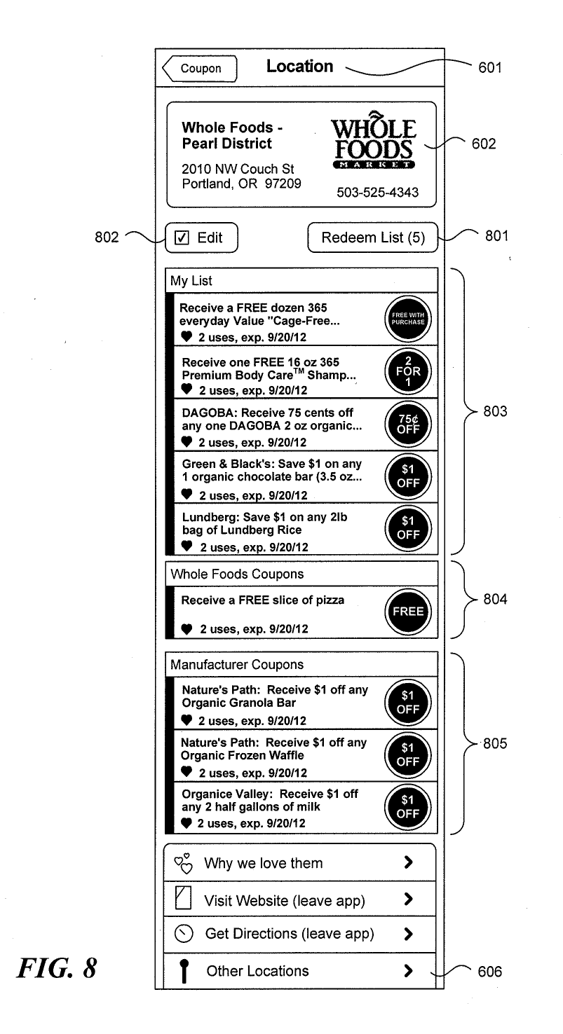

In step 308, the facility presents a “Location” display with a list of coupons to be redeemed, shown in FIG. 8. The “Location” display of FIG. 8 shares with the displays shown in FIG. 6 and FIG. 7 the “Location” title bar 601, the information about the selected merchant location 602 and (where applicable) the other locations button 606. The display of FIG. 8 also contains a “My List” section 803 listing selected coupon offers (e.g., offers selected and saved in step 307). In some embodiments, the facility displays the coupons in the “My List” section in an order tailored to the user, e.g., by listing recently added offers, coupons flagged by the user as favorites, soon-to-expire offers, etc. above others or, e.g., by listing the coupons in the order that the corresponding items are likely to be encountered in the store, either in a traversal route typical across all customers or in a traversal route typical of the present user. Below the “My List” section 803, the facility displays unselected merchant coupons 804 and unselected manufacturer coupons 805. The display also includes a button 802 enabling the user to edit the user's selections of coupons in the “My List” section 803 and a “Redeem List” button 801 enabling the user to redeem the offers in the “My List” section 803 at the merchant location 602. In the illustrated embodiment, the “Redeem List” button 801 also displays the number of coupons in the user's “My List” section 803, in this case, five.

In step 309, the facility branches based upon the button selected by the user. If the user selects the “Redeem List” button 801, then the facility continues in step 310 (in some embodiments, after confirming that the user wishes to redeem all the coupons in the user's “My List” section 803); if the user selects the edit button 802, then the facility continues in step 307; if the user selects one of the individual coupons in either the user's “My List” section 803, the unselected merchant coupon list 604, or the unselected manufacturer coupon list 605, then the facility continues through connector C1 to step 319 in FIG. 3C.

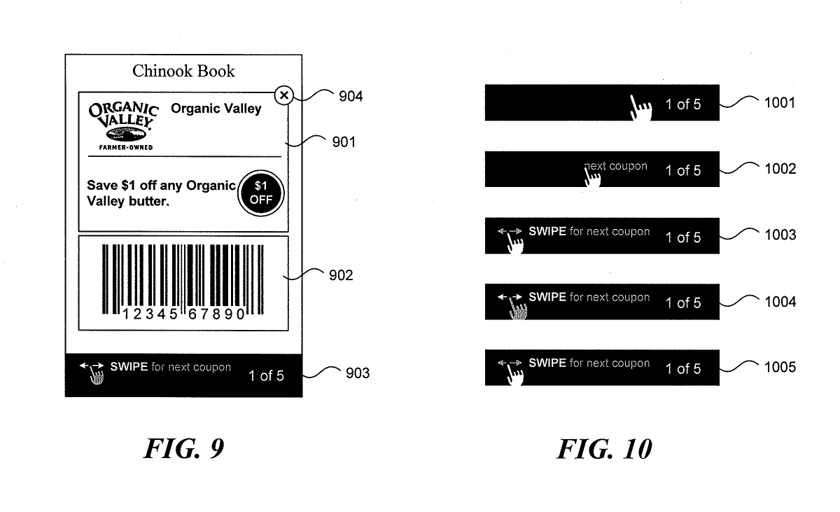

Continuing in FIG. 3A, in step 310, the facility presents a coupon redemption display, shown in FIG. 9. Generally, the user should only choose to redeem a coupon through this display in the presence of a cashier or other representative of the merchant who is able to subsequently observe the display of the mobile device to review and validate a redemption display. This display includes a coupon offer description 901 that indicates what the offer encompasses. The display also includes a redemption code 902 that can be scanned, e.g., by a cashier at the point of purchase. In the illustrated embodiment, the redemption code 902 is a Universal Product Code (UPC) bar code; those skilled in the art will appreciate that the facility can utilize many different types of codes. For example, numeric price look-up (PLU) codes are commonly used for fresh produce, and newer code formats like QR Code 2D/matrix barcodes and GS1 DataBar bar codes can contain more precise offer information than a UPC code. The cashier can either optically scan a bar code displayed as part of the coupon or type in the number included with it, e.g., “12345 67890” for the code shown in FIG. 9. In addition to information about the offer, the display shown in FIG. 9 includes an animation 903 directing the user to present each of the coupons to be redeemed, and a close button 904 to cancel redemption of a particular offer. While the facility is presenting the FIG. 9 display, the user shows it to the cashier or other representative of the merchant in order to complete the redemption of the coupon. When a representative of the merchant sees identifying information for the merchant and detail of the corresponding deal 901; a code for the deal 902 for scanning or entering into the merchant's systems; and an animation 903 that the representative has been trained to look for in connection with such coupons, the representative is able to determine that the coupon is legitimate and has been consumed by its redemption, and in response provide to the customer the deal to which the coupon corresponds.

An embodiment of the animation 903 from FIG. 9 is shown in greater detail in FIG. 10. The animation 903 both assists the user in navigating through the list of coupons being redeemed, and helps a cashier verify that the coupon is authentically being presented by the facility and is not, e.g., a still picture of a coupon that may no longer be valid. The illustrated animation sequence has five stages, and at all times shows which coupon, out of the total number of coupons to be redeemed, is being shown. In stage 1001, a hand icon comes up from the bottom of the display and swipes from right to left (the direction that the user would typically swipe a finger to advance to the next coupon to be redeemed). In stage 1002, the hand icon swipe reveals the text “SWIPE for next coupon” as it passes by. In stage 1003, the hand icon stops and arrows come out from the fingertip. In stages 1004-1005, the arrows fade in and out from white to dark or semi-transparent, and that portion of the animation continues looping while the coupon is displayed.

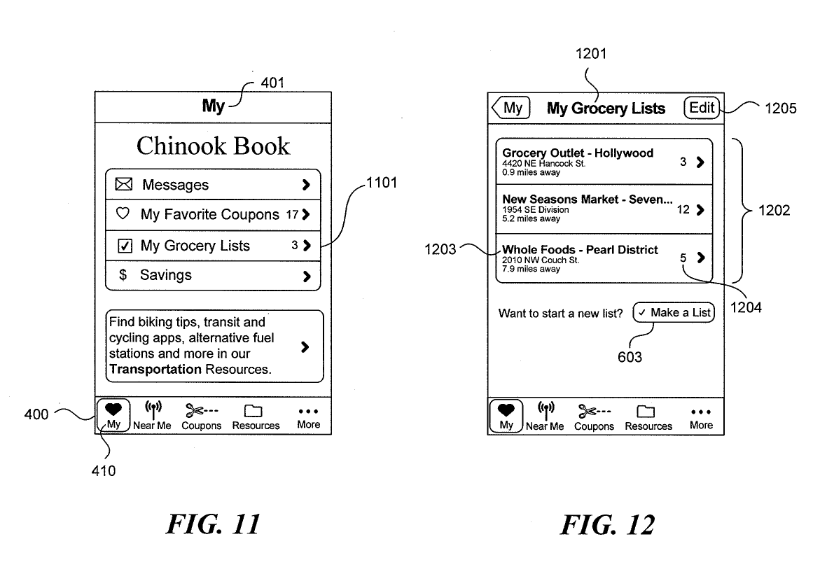

Returning in FIG. 3A to step 302, upon selecting the “My” button in the button bar, if the user has previously created one or more lists of coupons for redemption at particular merchants or merchant locations, then the facility continues in step 311. In step 311, the facility presents a “My” display, shown in FIG. 11. Like the “My” display of step 303 shown in FIG. 4, the title bar 401 displays “My”, and the “My” button 410 in the button bar 400 is highlighted. The FIG. 11 “My” display includes, however, instead of the “Make a Grocery List” button 402 in FIG. 4, a button 1101 labeled “My Grocery Lists” that displays the number of already-created lists, in this case three. After the user selects the button 1101, the facility continues in step 312.

In step 312, the facility presents a display of the user's lists, shown in FIG. 12. The illustrated embodiment is titled “My Grocery Lists” 1201 and contains a list 1202 of three merchant locations (grocery stores) for which the user has selected a list of coupons for redemption; those skilled in the art will appreciate that the facility is not limited to coupons of any particular type or merchants of any particular category. An example of a displayed merchant location for which the user has made a grocery list 1203 includes the name and address of the merchant location and the number of coupons in the list associated with that merchant location 1204, in this case five. The display also includes an edit button 1205 by which the user can delete one or more existing lists, and a “Make a List” button 603 by which the user can create a new list.

In step 313, the facility branches based upon the button selected by the user. If the user selects the “Make a List” button 603, then the facility continues in step 307; if the user selects the edit button, then the facility presents a display (not shown) allowing the user to delete any of the existing lists, and then continues in either step 312 (if any lists remain) or step 303 (if none remain); and if the user selects one of the existing lists of coupons selected for redemption at a particular merchant location, the facility continues in step 308.

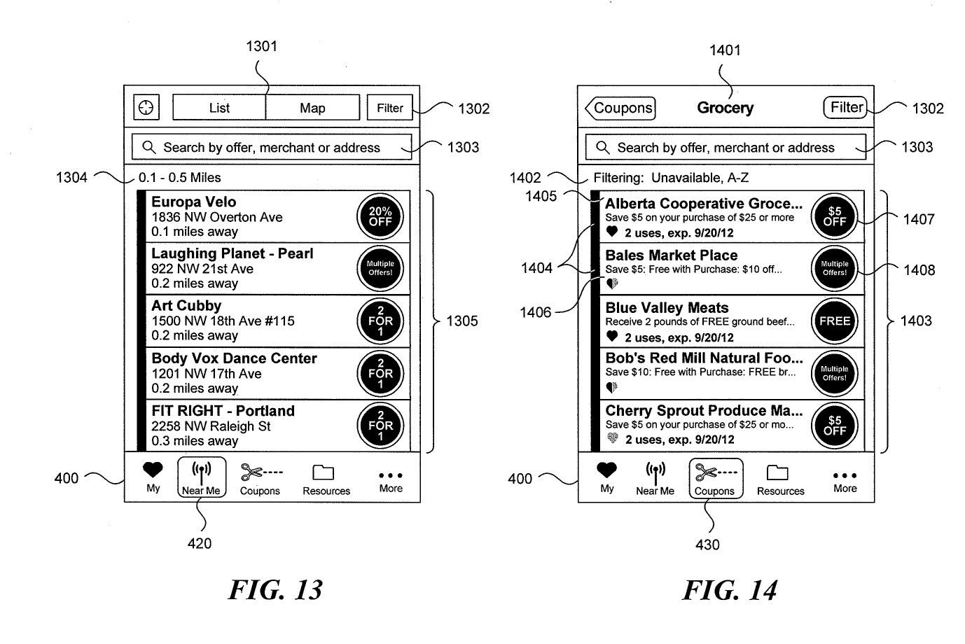

Turning to FIG. 3B, upon the user's selection of a “Near Me” button in the button bar in step 301, the facility continues through connector B1 to step 314. In step 314, the facility presents a “Near Me” display, shown in FIG. 13. The button bar 400 includes a highlighted “Near Me” button 420. The display includes a List/Map toggle button 1301 for switching the display between a list view, as illustrated in FIG. 13, and a map view (not shown). The “Near Me” list display includes a list of coupons for merchants who are geographically near the user's present location as determined, e.g., by the mobile device using GPS, cell tower triangulation, Wi-Fi hotspot location, system services, or user input. The display includes, for each of a number of radius ranges from the user 1304 (of which, in the illustrated example, only listings in the radius range 0.1-0.5 miles are visible), a list of merchant locations within that radius range 1305. The facility enables the user to filter the displayed merchant locations using the filter button 1302, e.g., to show only merchant locations with coupons available to the user or only establishments that are currently open for business. The facility also enables the user to search using a provided search bar 1303 to find an offer, a merchant, or a merchant location address relating to a user-entered search term. After the user selects a merchant location from the list 1305 (or from the map view), the facility continues in step 315.

The facility branches in step 315 based on whether the user has created a list for the selected location: if so, the facility continues through connector A3 to step 308 shown in FIG. 3A; if not, the facility continues through connector A2 to step 305 shown in FIG. 3A.

Turning again to FIG. 3B, upon the user's selection of a “Coupons” button in the button bar in step 301, the facility continues through connector B2 to step 316. In step 316, the facility presents a display of coupon offers organized by merchant location, shown in FIG. 14. The button bar 400 includes a highlighted “Coupons” button 430. The illustrated example includes a list of offers from merchants in the grocery category 1403, as indicated by the “Grocery” title 1401 and the color-coded bands 1404 associated with each individual coupon offer. The facility enables the user to filter or search displayed merchant locations using the filter button 1302 (with active filtering criteria 1402 displayed) and the search bar 1303 as described above in connection with FIG. 13. In the coupon offers display of FIG. 14, the information displayed for each merchant location is more offer-focused than, e.g., in the “Near Me” display of FIG. 13. For example, where the “Near Me” display of FIG. 13 highlights merchant location addresses and distances from the user, the coupon offers display of FIG. 14 highlights the details of the offer or offers available at each merchant location. In the illustrated embodiment, for a merchant location 1405 that has one offer available, the display provides details of that offer (here, “Save $5 on your purchase of $25 or more”, and indications of how many times the coupon can be used and when it expires) and an offer icon 1407 summarizing the essence of the deal (here, “$5 OFF”); and for a merchant location 1406 that has multiple offers available, the display provides abbreviated summaries of the essences of those offers (here, “Save $5,” “Free with Purchase,” and “$10 off”) and a multiple offer icon 1408 indicating “Multiple Offers!” in a differing shade or color). After the user selects a merchant from the list of merchants with available offers 1403, the facility continues in step 317.

The facility branches in step 317 based on whether the selected location has a single coupon offer (as, e.g., merchant location 1405 from FIG. 14) or multiple coupon offers (as, e.g., merchant location 1406 from FIG. 14). If the selected location has a single coupon offer, then the facility continues through connector C1 to step 319 in FIG. 3C. If the selected location has multiple coupon offers, then the facility continues in step 318.

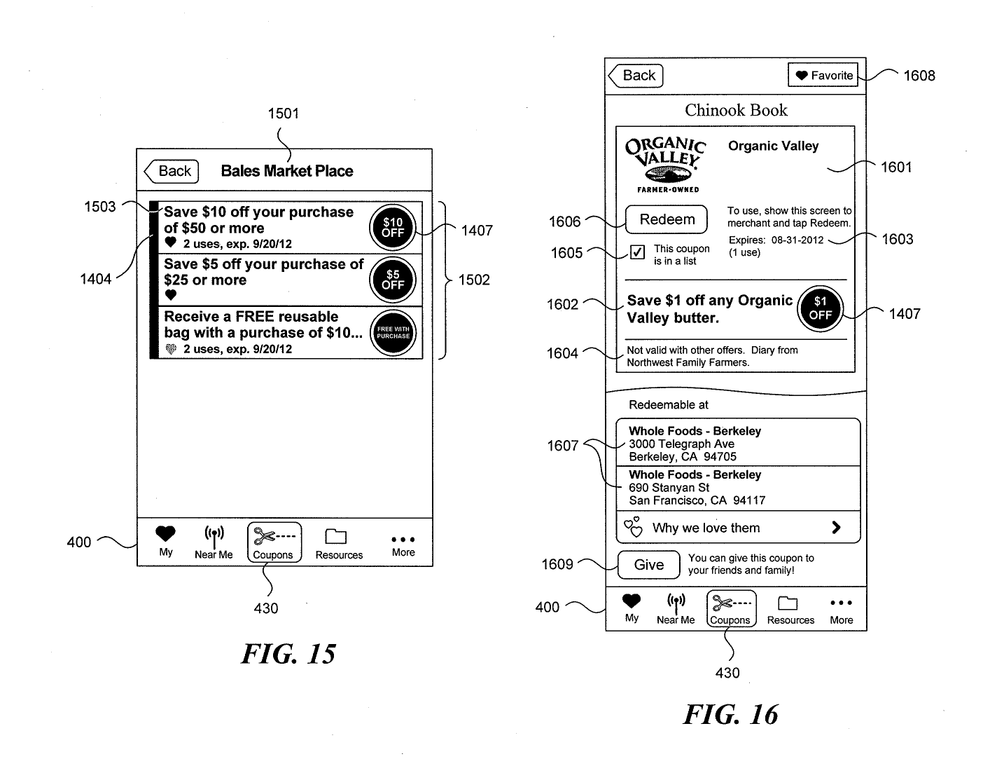

Continuing in FIG. 3B, in step 318, the facility presents a merchant location coupons display, shown in FIG. 15. As with the coupon offers display of FIG. 14, the button bar 400 includes a highlighted “Coupons” button 430. This display includes a title identifying the merchant 1501, a set of available coupon offers for the selected merchant location 1502, each individual coupon presented with information about the offer (including expiration and available uses) 1503 with a color-coded band identifying its coupon category 1404 and an offer icon 1407. Through this display, the facility enables the user to choose an individual coupon offered by a merchant that has several offers available. After the user selects an individual coupon, the facility continues through connector C1 to step 319 in FIG. 3C.

As an alternative to steps 316-318 shown in FIG. 3B, in some embodiments (not shown), the facility presents a list of coupon categories (e.g., dining, entertainment, fashion, grocery, home, travel, and wellness), by which the user is able to display coupons within a chosen category, and an option to show coupons in all categories. In some embodiments (not shown), the facility presents a list of coupons, e.g., a list of all coupons, a list of available coupons, or a list of manufacturer coupons, which may be sortable, filterable, or searchable, enabling the user to select an individual coupon. Upon selection of a coupon, the facility displays a list of merchant locations where the selected coupon can be redeemed (not shown), which may be sortable, filterable, or searchable by various criteria, e.g., distance from the user. After the user selects an individual coupon and a merchant location where the coupon can be redeemed, the facility continues through connector C1 to step 319 in FIG. 3C.

Turning to FIG. 3C, upon the user's selection of an individual manufacturer coupon offer, the facility continues in step 319. In step 319, the facility presents an offer display, shown in FIG. 16. The button bar 400 includes a highlighted “Coupons” button 430. This display includes information identifying the manufacturer offering the offer 1601, a description of the offer itself 1602 (along with a summary offer icon 1407), available uses and coupon expiration information 1603, and restrictions on use of the offer 1604. This display also includes an indication, if applicable, that the user has selected the coupon in a list 1605, a “Redeem” button 1606, and one or more buttons indicating what merchant locations (or if more than three, a button indicating how many) accept the coupon 1607. Among other options available from the offer display are a favorite/unfavorite toggle button 1608 enabling the user to add or remove the coupon to or from a list of favorites, and a button to give the coupon to another person 1609.

In step 320, the facility branches based upon the button selected by the user. If the user selects the favorite/unfavorite button 1608 or the give button 1609, the facility continues in step 319 as before. If the user selects a button 1607 indicating one of up to three merchant locations that accept the coupon, the facility continues through connector A3 to step 308 shown in FIG. 3A. If the user selects a button 1607 indicating that more than three merchant locations accept the coupon, the facility presents a display (not shown) listing locations of that merchant for the user to select. When the user selects one of the locations, the facility continues through connector A3 to step 308 shown in FIG. 3A. If the user selects the “Redeem” button 1606, then the facility continues in step 321.

In step 321, the facility branches based on whether the user has previously placed the coupon chosen for redemption into a list of coupons for redemption at a particular merchant location. If the coupon is not already in a list, the facility presents a display (not shown) prompting the user to choose a location that is valid for redeeming the coupon; and once a location is chosen (or if it was chosen before step 319, e.g., via selecting an individual offer from a location display as in steps 305-306 or 308-309), the facility continues through connector A4 to step 310 shown in FIG. 3A, enabling the user to redeem the individual offer. If the chosen coupon is already in a list, the facility continues in step 322.

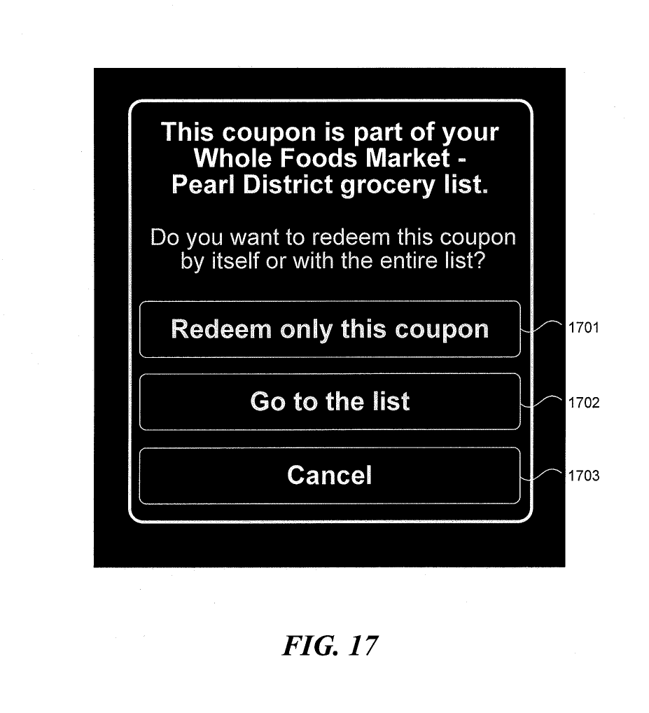

In step 322, the facility presents a dialog, shown in FIG. 17. The dialog informs the user that the coupon the user wants to redeem is part of a list of coupons that the user selected for redemption at a particular merchant location, and asks the user whether to redeem the chosen coupon by itself 1701, to go to the list 1702, or to cancel the redemption 1703. After the user selects one of the dialog buttons, the facility continues in step 323.

In step 323, the facility branches based upon the button selected by the user. If the user selects the “Redeem only this coupon” button 1701, the facility continues through connector A4 to step 310 shown in FIG. 3A, enabling the user to redeem the individual offer. If the user selects the “Go to the list” button 1702, the facility continues through connector A3 to step 308 shown in FIG. 3A, enabling the user to redeem the list of selected coupons. And if the user selects the “Cancel” button 1703, the facility continues in step 319.

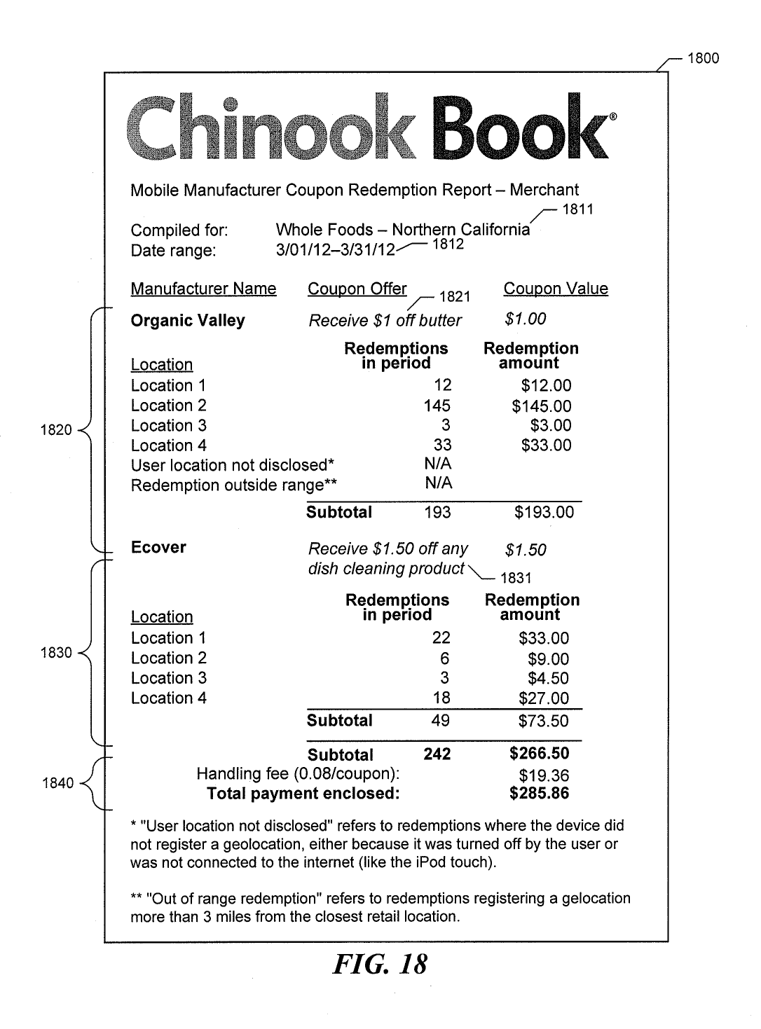

FIG. 18 is a report diagram showing a sample manufacturer coupon redemption report typical of those generated for a merchant by the facility in some embodiments. The report 1800 contains identifying information for the report, including the name 1811 of the merchant whose manufacturer coupon redemptions are summarized and a date range 1812 for which manufacturer coupon redemptions are summarized. In some embodiments, this date range may be specified by the merchant as part of generating the report. In some embodiments (not shown), the facility includes in the report multiple columns, each corresponding to a different date range. The report includes section 1820 containing information about redemptions of an Organic Valley® manufacturer coupon for one dollar off butter 1821, and section 1830 containing information about redemptions of an Ecover® manufacturer coupon for one-and-a-half dollars off the manufacturer's cleaning products 1831. Each of these sections 1820 and 1830 indicates, for each of the merchant's locations, the total number and dollar value amount of the relevant coupon that were redeemed at that location during the specified date range 1812. In some embodiments, the report indicates the total number and dollar amount redeemed since the coupon was first published. The report also indicates redemptions for which the user's location was not disclosed (e.g., if the user disabled mobile device geo-location services) and/or redemptions that occurred too far from any of the merchant's locations to be attributable to a location (e.g., redemptions that were accidental, or occurred at a merchant location at a time when the wireless device was unable to accurately determine its location). Section 1840 provides a total of the reimbursement provided to the merchant for redeeming the manufacturer coupons. The merchant can derive a wealth of useful information from this report, including, e.g., which kinds of coupons are most popular overall, as well as at which particular locations. For example, at this merchant, the Organic Valley coupon was more frequently used than the Ecover coupon, and the Organic Valley coupon was most frequently used at Location 2.

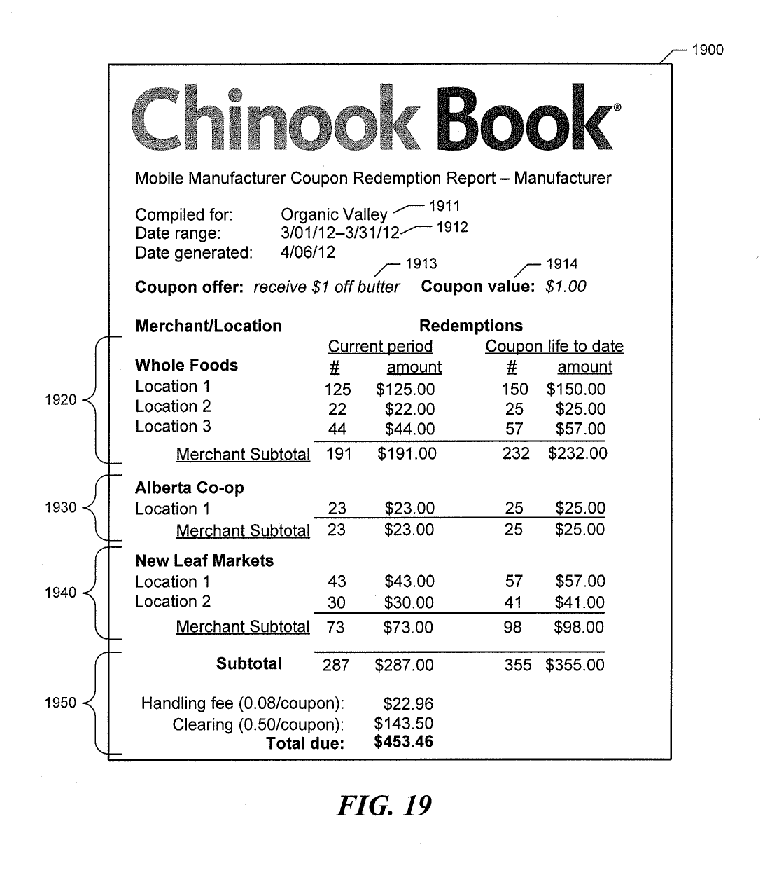

FIG. 19 is a report diagram showing a sample manufacturer coupon redemption report typical of those generated for a manufacturer by the facility in some embodiments. The report 1900 contains identifying information for the report, including the name 1911 of the manufacturer whose manufacturer coupon redemptions are summarized and a date range 1912 for which manufacturer coupon redemptions are summarized. In some embodiments, this date range may be specified by the manufacturer as part of generating the report. In some embodiments (not shown), the facility includes in the report multiple columns, each corresponding to a different date range. The report identifies the particular manufacturer coupon 1913 and the coupon's value 1914, in this case an Organic Valley® manufacturer coupon for one dollar off butter. The report includes sections 1920, 1930, and 1940 containing information about redemptions of the specified manufacturer coupon at three different merchants and at each of the merchants' locations. Each of these sections 1920, 1930, and 1940 indicates, for each of the merchant's locations, the total number and dollar value amount of the relevant coupon that were redeemed at that location during the specified date range 1912 and during the entire life of the coupon, i.e., since the coupon was first published. In some embodiments, the report also indicates redemptions for which the user's location was not disclosed and/or redemptions that were not attributed to any merchant (e.g., redemptions that were accidental). Section 1950 provides a total of the amount due from the manufacturer for the redemptions of the manufacturer coupons. A typical report may contain the information shown in FIG. 19 for each electronic coupon published by the manufacturer, as well as redemption information aggregated across the manufacturer's coupons (not shown). The manufacturer can derive a wealth of useful information from this report, including which kinds of coupons are most effective overall, as well as at which particular merchants and particular merchant locations. For example, for this manufacturer, the dollar off butter coupon was more frequently used at Whole Foods Market® than at the Alberta Co-Op or the New Leaf Markets, and it was most frequently used at Location 1.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A method in a mobile computing system having a processor, a display device, and a communication component for redeeming a distinguished electronic manufacturer coupon, the method comprising:
accessing information about locations of a plurality of merchants that are in an identified geographic area;
displaying, on the display device, at least one of the merchant locations in the identified geographic area;
receiving user input selecting a displayed merchant location;
accessing information about one or more offers redeemable at the selected merchant location, wherein such offers include at least one electronic manufacturer coupon redeemable at the selected merchant location;
displaying information about the selected merchant location comprising information about at least one of the offers redeemable at the selected merchant location, wherein the at least one of the offers displayed include a distinguished electronic manufacturer coupon;
receiving user input adding the distinguished electronic manufacturer coupon to a set of offers to be redeemed at the selected merchant location;
displaying information about the selected merchant location comprising the set of offers to be redeemed;
receiving user input to redeem the offers in the set of offers; and
for each offer in the set of offers:
displaying information about the offer comprising a description of the offer, a code for redemption of the offer, and an animation sequence;
recording, by the processor, data about the redemption; and
transmitting, via the communication component, the recorded data about the redemption.

2. A computer-readable storage medium having contents adapted to cause a computer to perform a method for redeeming a distinguished electronic manufacturer coupon, the method comprising:
receiving user input selecting a merchant location;
accessing information about one or more offers redeemable at the selected merchant location, wherein such offers include at least one electronic manufacturer coupon redeemable at the selected merchant location;
displaying information about the selected merchant location comprising information about at least one of the offers redeemable at the selected merchant location, wherein the at least one of the offers displayed include a distinguished electronic manufacturer coupon;
receiving user input requesting redemption of the distinguished electronic manufacturer coupon at the selected merchant location; and
in response to receiving user input requesting redemption:
displaying information about the distinguished electronic manufacturer coupon comprising a code for redemption of the offer;
recording data about the redemption; and
transmitting the recorded data about the redemption.

3. The computer-readable storage medium of claim 2 wherein the method is performed in a mobile device.

4. The computer-readable storage medium of claim 2 wherein displaying information about the distinguished electronic manufacturer coupon further comprises displaying a description of the offer.

5. The computer-readable storage medium of claim 2 wherein displaying information about the distinguished electronic manufacturer coupon further comprises displaying an animation sequence.

6. The computer-readable storage medium of claim 2, further comprising authenticating the user as being entitled to redeem offers redeemable by authenticated users at the selected merchant location.

7. The computer-readable storage medium of claim 2, further comprising:
identifying a geographic area;
accessing information about locations, in the identified geographic area, of a plurality of merchants; and
displaying at least one of the merchant locations in the identified geographic area.

8. The computer-readable storage medium of claim 2, further comprising receiving user input adding the distinguished electronic manufacturer coupon to a set of offers to be redeemed at the selected merchant location.

9. The computer-readable storage medium of claim 8 wherein receiving user input adding the distinguished electronic manufacturer coupon to a set of offers to be redeemed comprises receiving user input to initialize a set of offers to be redeemed.

10. The computer-readable storage medium of claim 2, further comprising:
determining that the distinguished electronic manufacturer coupon is included in a set of offers to be redeemed at the selected merchant location; and
prompting the user whether to redeem additional offers in the set of offers.

11. The computer-readable storage medium of claim 10, further comprising, upon redemption of each offer in the set of offers to be redeemed, removing the offer from the set of offers to be redeemed.

12. The computer-readable storage medium of claim 10, further comprising, in connection with displaying information about an offer in the set of offers, receiving user input canceling redemption of an offer such that it is excluded from the set of offers for which data about the redemption is recorded and transmitted.

13. The computer-readable storage medium of claim 2 wherein the code for redemption of the offer is a Universal Product Code (UPC) bar code.

14. The computer-readable storage medium of claim 2 wherein the code for redemption of the offer is a GS1 DataBar bar code.

15. The computer-readable storage medium of claim 2 wherein the code for redemption of the offer is a price look-up (PLU) code number.

16. The computer-readable storage medium of claim 2 wherein the code for redemption of the offer is a QR Code.

17. The computer-readable storage medium of claim 2 wherein data about the redemption comprises the identity of the offer, the identity of the user, the time and date, and the geographic location at the time of redemption.

18. A computer-readable storage medium having contents adapted to cause a mobile computing system to perform a method for selecting a distinguished electronic manufacturer coupon for redemption, the method comprising:
accessing information about one or more offers, wherein such offers include at least one electronic manufacturer coupon;
displaying information about at least one of the offers, including at least a distinguished electronic manufacturer coupon;
receiving user input selecting the distinguished electronic manufacturer coupon for redemption;
identifying a geographic area; and
accessing information about merchant locations in the identified geographic area that accept the distinguished electronic manufacturer coupon.

19. The computer-readable storage medium of claim 18 wherein identifying a geographic area comprises receiving user input designating a geographic area.

20. The computer-readable storage medium of claim 18 wherein identifying a geographic area comprises accessing information about the location of the mobile computing system.

21. The method of claim 18 wherein accessing information about merchant locations in the identified geographic area that accept the distinguished electronic manufacturer coupon comprises accessing information about locations of a plurality of merchants in the identified geographic area that accept the distinguished electronic manufacturer coupon.

22. The method of claim 21 wherein at least one merchant in the plurality of merchants has more than one location in the identified geographic area.

23. The computer-readable storage medium of claim 18, further comprising displaying a map including an indication of at least one merchant location that accepts the distinguished electronic manufacturer coupon.

24. The computer-readable storage medium of claim 18, further comprising:
receiving user input requesting redemption of the distinguished electronic manufacturer coupon at a merchant location that accepts the distinguished electronic manufacturer coupon;
displaying information about the distinguished electronic manufacturer coupon comprising a description of the offer and a code for redemption of the offer;
recording data about the redemption; and
transmitting the recorded data about the redemption.

25. The computer-readable storage medium of claim 24 wherein receiving user input requesting redemption of the distinguished electronic manufacturer coupon at a merchant location that accepts the distinguished electronic manufacturer coupon comprises:
receiving user input requesting redemption of the distinguished electronic manufacturer coupon; and
selecting a merchant location that accepts the distinguished electronic manufacturer coupon.

26. The method of claim 25 wherein selecting a merchant location that accepts the distinguished electronic manufacturer coupon comprises:
displaying at least one merchant that has multiple locations in the identified geographic area;
receiving user input selecting a displayed merchant that has multiple locations in the identified geographic area;
displaying at least one of the multiple locations; and
receiving user input selecting a displayed location;

27. The computer-readable storage medium of claim 25 wherein selecting a merchant location that accepts the distinguished electronic manufacturer coupon comprises identifying the closest merchant location that accepts the distinguished electronic manufacturer coupon.

28. The computer-readable storage medium of claim 24 wherein displaying information about the distinguished electronic manufacturer coupon further comprises displaying a description of the offer.

29. The computer-readable storage medium of claim 24 wherein displaying information about the distinguished electronic manufacturer coupon further comprises displaying an animation sequence.

30. A computer-readable storage medium having contents adapted to cause a mobile computing system to perform a method for redeeming a distinguished electronic manufacturer coupon, the method comprising:
accessing information about one or more offers, wherein such offers include at least one electronic manufacturer coupon;
displaying information about at least one of the offers, including at least a distinguished electronic manufacturer coupon;
receiving user input selecting the distinguished electronic manufacturer coupon for redemption;
displaying information about the distinguished electronic manufacturer coupon comprising a description of the offer and a code for redemption of the offer;
recording data about the redemption; and
transmitting the recorded data about the redemption.

31. A method in a computing system having a processor, memory, and a communication component for providing access to an electronic manufacturer coupon, the method comprising:
accessing information about an electronic manufacturer coupon offer;
receiving, from at least one merchant that has one or more locations, an indication that at least one merchant location will redeem the offer;
creating, by the processor, a first data structure to associate the electronic manufacturer coupon offer with merchant locations that will redeem the offer;
storing, in the first data structure, an association between the offer and the indicated merchant location;
transmitting the data structure, via the communication component, to a third party computing device;
receiving, from the third party computing device, information describing a redemption transaction in which a merchant location associated in the data structure with the electronic manufacturer coupon offer redeemed the offer;
creating, by the processor, a second data structure to aggregate information describing transactions in which a merchant location redeems the electronic manufacturer coupon offer; and
storing, in the second data structure, the redemption transaction information.

32. The method of claim 31 wherein receiving an indication that at least one merchant location will redeem the offer comprises receiving an indication that the merchant will redeem the offer, at any merchant location.

33. The method of claim 31, further comprising determining, by the processor, using the information in the second data structure, the number of redemptions of the electronic manufacturer coupon offer at each merchant location.

34. The method of claim 31, further comprising analyzing the aggregated information in the second data structure to identify electronic manufacturer coupon offer redemption transactions that are likely to be improper.

35. The method of claim 34 wherein analyzing the aggregated information in the second data structure to identify possible manufacturer coupon misredemption comprises identifying manufacturer coupon redemption patterns that fall outside an accepted range.
